(19) United States
(12) Patent Application Publication
(10) Pub. No.: US 2007/0174047 A1
(43) Pub. Date: Jul. 26, 2007

(54) METHOD AND APPARATUS FOR RESYNCHRONIZING PACKETIZED AUDIO STREAMS

(76) Inventors: Kyle D. Anderson, Everett, WA (US); Philippe Gournay, Sherbrooke (CA)

Correspondence Address: DITTHAVONG MORI & STEINER, P.C., 918 Prince St., Alexandria, VA, 22314, US

(21) Appl. No.: 11/549,817

(22) Filed: Oct. 16, 2006

Related U.S. Application Data
(60) Provisional application No. 60/727,908, filed on Oct. 18, 2005.

(51) Int. Cl. G10L 11/04

(52) U.S. Cl. 704/207

(57) ABSTRACT

An approach is provided for maintaining natural pitch periodicity of the speech or audio signal when processing a late frame in a predictive decoder. Concealment is performed to replace a late frame. The late frame that includes audio information is detected. A pitch phase difference introduced by the concealment is determined. The pitch phase difference is compensated for before playing out a subsequent frame that follows the late frame.

### RELATED APPLICATIONS

This application claims the benefit of the earlier filing date under 35 U.S.C. §119(e) of U.S. Provisional Application Ser. No. 60/727,908 filed Oct. 18, 2005, entitled “Method and Apparatus for Resynchronizing Packetized Audio Streams when Processing Late Packets,” the entirety of which is incorporated by reference.

### FIELD OF THE INVENTION

Embodiments of the invention relate to communications, and more particularly, to processing of data packets.

### BACKGROUND

Radio communication systems, such as cellular systems (e.g., spread spectrum systems (such as Code Division Multiple Access (CDMA) networks), or Time Division Multiple Access (TDMA) networks) and broadcast systems (e.g., Digital Video Broadcast (DVB)), provide users with the convenience of mobility along with a rich set of services and features. This convenience has spawned significant adoption by an ever growing number of consumers as an accepted mode of communication for business and personal uses. To promote greater adoption, the telecommunication industry, from manufacturers to service providers, has agreed at great expense and effort to develop standards for communication protocols that underlie the various services and features. One key area of effort involves the transport of speech or audio streams; e.g., Voice over Internet Protocol (VoIP). It is recognized that traditional approaches do not adequately address signal quality associated with the decoding process when packets are delayed and/or lost. This delay or loss of packets causes a loss of synchronization within the decoder as these packets are not decoded. Consequently, this negatively impacts the signal quality that is played out, particularly with respect to pitch.

Therefore, there is a need for effectively maintaining signal quality of a packetized audio stream when speech or audio data is delayed or lost.

### SOME EXEMPLARY EMBODIMENTS

These and other needs are addressed by the invention, in which an approach is presented for maintaining natural pitch periodicity of the speech or audio signal.

According to one aspect of an embodiment of the invention, a method comprises detecting a late frame that includes audio information, wherein concealment is performed based upon the detected late frame. The method also comprises determining a pitch phase difference introduced by the concealment. The method further comprises compensating for the pitch phase difference before playing out a subsequent frame that follows the late frame.

According to another aspect of an embodiment of the invention, an apparatus comprises a pitch phase compensation logic configured to detect a late frame that includes audio information, wherein concealment is performed based upon the detected late frame. The pitch phase compensation logic configured to determine a pitch phase difference introduced by the concealment, and to compensate for the pitch phase difference before playing out a subsequent frame that follows the late frame.

According to yet another aspect of an embodiment of the invention, a system comprises means for detecting a late frame that includes audio information, wherein concealment is performed based upon the detected late frame; means for determining a pitch phase difference introduced by the concealment; and means for compensating for the pitch phase difference before playing out a subsequent frame that follows the late frame.

Still other aspects, features, and advantages of the embodiments of the invention are readily apparent from the following detailed description, simply by illustrating a number of particular embodiments and implementations, including the best mode contemplated for carrying out the embodiments of the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings and in which like reference numerals refer to similar elements and in which:

FIGS. 1A and 1B are, respectively, a diagram of an exemplary receiver capable of providing resynchronization of audio streams and a flowchart of an audio recovery process, in accordance with various embodiments of the invention;

FIG. 2 is a diagram of exemplar decoder outputs associated with one late frame;

FIG. 3 is a diagram of decoded signals of a conventional concealment procedure and of a late packet processing procedure according to an embodiment of the invention;

FIG. 4 is a diagram of excitation signals involving use of a conventional concealment procedure and a late packet processing procedure;

FIG. 5 is a diagram of the relationships among the signals utilized in a resynchronization procedure, according to an embodiment of the invention;

FIG. 6 is a flowchart a resynchronization procedure, according to an embodiment of the invention;

FIG. 7 is a diagram of excitation signals involving use of the resynchronization procedure, according to an embodiment of the invention;

FIGS. 8A-8D are flowcharts of processes associated with determining and accounting for pitch phase difference, according to various embodiments of the invention;

FIG. 9 is a diagram of hardware that can be used to implement an embodiment of the invention;

FIGS. 10A and 10B are diagrams of different cellular mobile phone systems capable of supporting various embodiments of the invention;

FIG. 11 is a diagram of exemplary components of a mobile station capable of operating in the systems of FIGS. 10A and 10B, according to an embodiment of the invention; and

FIG. 12 is a diagram of an enterprise network capable of supporting the processes described herein, according to an embodiment of the invention.

### DESCRIPTION OF THE PREFERRED EMBODIMENT

An apparatus, method, and software for resynchronizing audio streams are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although the embodiments of the invention are discussed with respect to a packet network, it is recognized by one of ordinary skill in the art that the embodiments of the inventions have applicability to any type of data network including cell-based networks (e.g., Asynchronous Transfer Mode (ATM)). Additionally, it is contemplated that the protocols and processes described herein can be performed not only by mobile and/or wireless devices, but by any fixed (or non-mobile) communication device (e.g., desktop computer, network appliance, etc.) or network element or node.

Among other telecommunications services, packet networks are utilized to transport packetized voice sessions (or calls). By way of example, these networks support the Internet Protocol (IP). Transmission over packet networks is characterized by variations in the transit time of the packets through the network, in which some packets are simply lost. The difference between the actual arrival time of the packets and a reference clock at the precise packet rate is called the jitter.

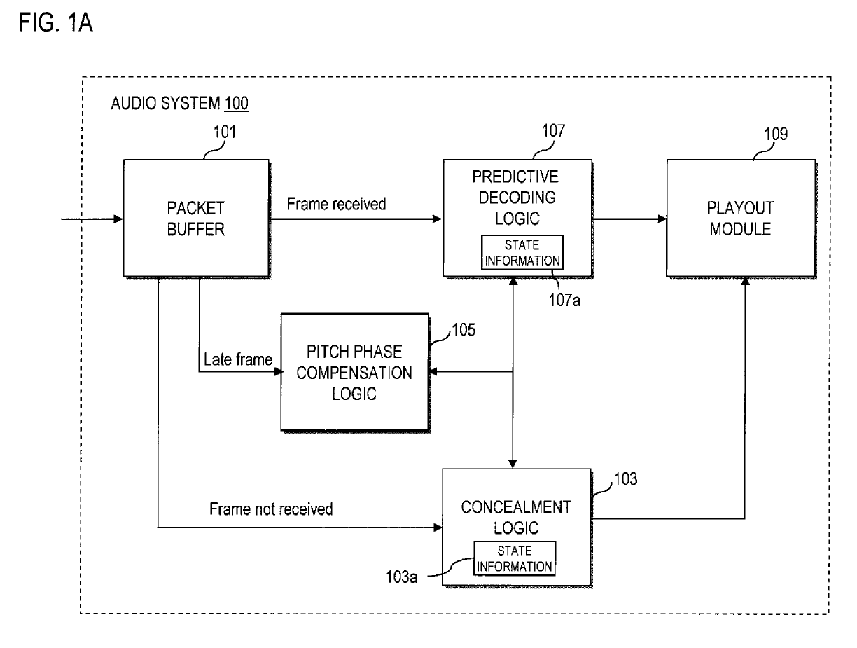

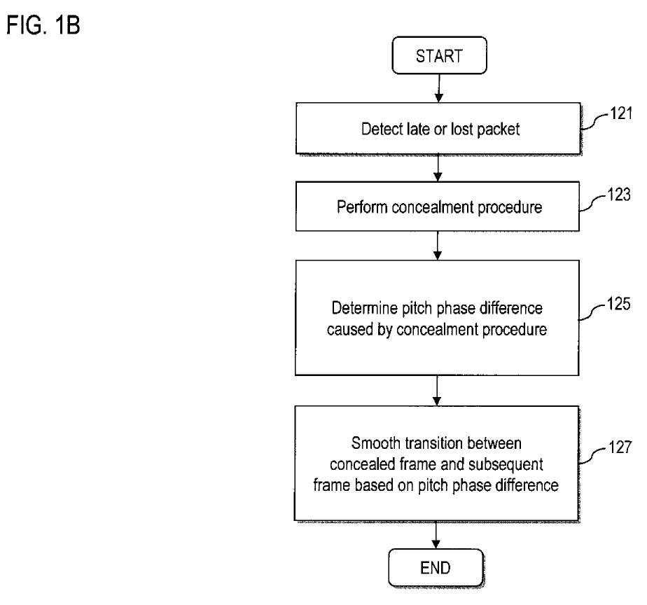

FIG. 1A illustrates a diagram of an exemplary receiver capable of providing resynchronization of audio streams, in accordance with various embodiments of the invention. By way of illustration, an audio system 100, such as a receiver, is explained in the context of audio information represented by data frames or packets—e.g., packetized voice, video streams with audio content, etc. The audio system 100 includes a packet buffer 101 that is configured for storing a packet that has been received. The system 100 also includes a concealment logic 103 for executing a concealment procedure for generating a replacement frame when a packet is not available. A pitch phase compensation logic 105 for smoothing the transitions between concealment outputs and subsequent outputs. The concealment logic 103 and pitch phase compensation logic 105 interoperate with a decoder (e.g., predictive decoding logic) 107, which outputs decoded frames to a playout module 109.

As an exemplary application, the audio system 100 can be implemented as a Voice over Internet Protocol (VoIP) receiver. Under this scenario, the buffer 101 can also be used to control the effects of jitter. As such, the buffer 101 transforms the irregular flow of arriving packets into a regular flow of packets, so that the speech decoder 107 can provide a sustained flow of speech to the listener. These flows can be data streams representing any type of aural information, including speech and audio. However, it is contemplated that the approach described herein can also be applied to video streams that include audio information.

The packet buffer 101 operates by introducing an additional delay, which is called “playout delay” (this delay is defined with respect to the reference clock that was, for example, started at the reception of the first packet). The playout delay can be chosen, for example, to minimize the number of packets that arrive too late to be decoded, while keeping the total end-to-end delay within acceptable limits.

Packets that arrive before their playout time are temporarily stored in a reception buffer. When their playout time occurs, they are taken from that buffer, decoded and played out via playout module 109. Lost packets and packets that arrive after their playout time cannot be decoded; consequently, a replacement speech or audio segment is computed. In addition, the decoder internal state is incorrect.

Under this scenario, a concealment procedure through concealment logic 103 is invoked instead of a normal decoding procedure to replace the missing speech or audio segment. The concealment logic 103 maintains internal state information 103a; such states can be effected by using a state machine, for example. The decoder 107 likewise maintains state information 107a for the decoding process.

Traditional concealment procedure has the drawback that an error is introduced in the concealed segment. Moreover, this concealment procedure does not correctly update the internal state of the decoder 107. Thus, due to the predictive nature of the decoder 107, an error introduced by the concealment procedure generally propagates in the segments that follow. It is noted that non-predictive coder/decoder (codecs) have no propagation of errors as each packet is independent.

Although late packets are most often considered as lost in the context of voice over packet networks, these late packets can be used to reduce error propagation, as explained in IEEE Journal on Selected Areas in Communications, entitled “Techniques for Packet Voice Synchronization,” Vol. SAC-1, No. 6, December 1983; which is incorporated herein by reference in its entirety.

When a packet is not lost but simply delayed, its contents can be used to update “a posteriori” the internal state of the decoder 107. This limits and, in some cases, stops the error propagation caused by the concealment. It is to be noted that great care must be taken however to ensure a smooth transition between the concealed output segment and the subsequent “updated” output segment computed with the updated internal state. This technique is detailed in an article by P. Gournay et al., entitled “Improved packet loss recovery using late frames for prediction-based speech coders,” ICASSP, April 2003 which is incorporated herein by reference in its entirety.

The concealment logic 103 of a predictive speech or audio decoder generally introduces a pitch phase difference during voiced or quasi-periodic segments. Such pitch phase difference, which is detrimental to signal quality, makes it difficult to use the traditional fade-in, fade-out technique when passing from the concealed output segment to the following “updated” output segment computed with a properly updated internal state.

In contrast to the traditional “fade-in fade-out” procedure, the pitch phase compensation logic 105 provides a process to effectively smooth the transition between those two segments. More specifically, it addresses the problem of how to maintain the natural pitch periodicity of the speech or audio signal when passing from one segment to another.

FIG. 1B is an exemplary flowchart of an audio recovery process, in accordance with various embodiments of the invention. In step 121, a late or lost packet is detected. Consequently, a concealment procedure is initiated to produce a replacement frame, as in step 123. Next, when the late frame is processed, the pitch phase difference caused by concealment procedure is determined, per step 125. In step 127, the process smoothes the transition between the concealed frame and a subsequent frame based on the determined pitch phase difference.

The resynchronization process described above, in an exemplary embodiment, has application to a CDMA 2000 1×EV-DO (Evolution-Data Optimized) system. It is recognized by one of ordinary skill in the art that the invention has applicability to any type of radio networks utilizing other technologies (e.g., spread spectrum systems in general, as well as time division multiplexing (TDM) systems) and communication protocols.

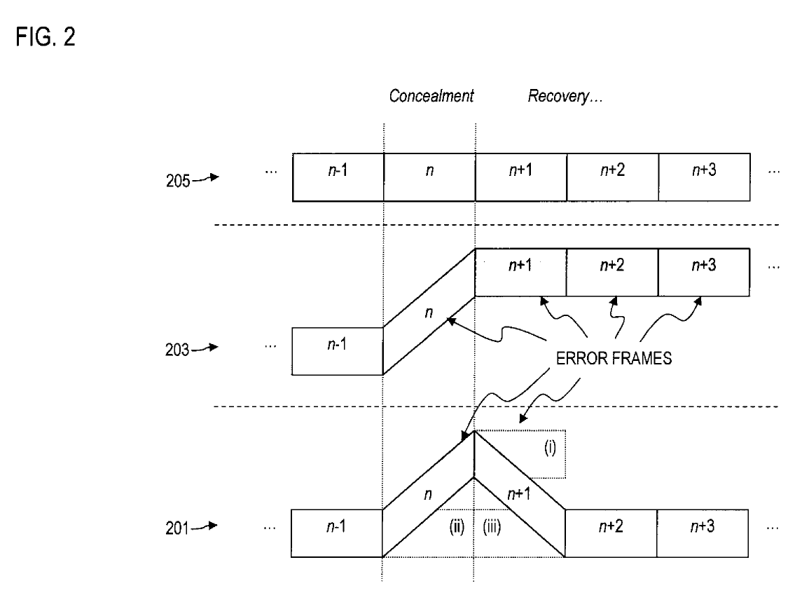

FIG. 2 is a diagram of exemplary decoder outputs associated with one late frame. Specifically, this figure illustrates the effects of a late frame when that frame is considered as lost (scenario 203) and when it is used to update the internal state of the decoder 107 (scenario 201). The correct output is shown in white, and the error propagation is shown in gray. Scenario 205 is the output of decoder 107 with no lost or late frame.

By way of example, binary frames are received and decoded normally up to frame n−1. Frame n is not available in time for the decoding. The concealment procedure generates some replacement output that differs from the expected output. Since the internal state of the decoder 107 is not updated correctly in the original decoder, the error introduced in frame n propagates in the following ones (scenario 203).

Assuming now that frame n arrives at the packet buffer 101 before the decoding of frame n+1 (scenario 201). The following scenarios are considered: (i) discard the content of frame n, and use the “bad” internal state produced by the concealment, and decode frame n+1 as normally performed in the decoder 107; or (ii) restore the internal state of the decoder 107 to its value at the end of frame n−1, decode frame n without outputting the decoded speech (which results in updating the internal state to its “good” value), and (iii) decode frame n+1 as if no error had occurred.

In one embodiment, some smoothing may be required to prevent any discontinuity at the boundary between frame n and frame n+1. This can be performed in the excitation domain by weighting signals (i) and (iii) (in FIG. 2) with fade-in, fade-out windows and taking the memories of synthesis filters from the internal state following the concealment (e.g., actual past synthesized sampled).

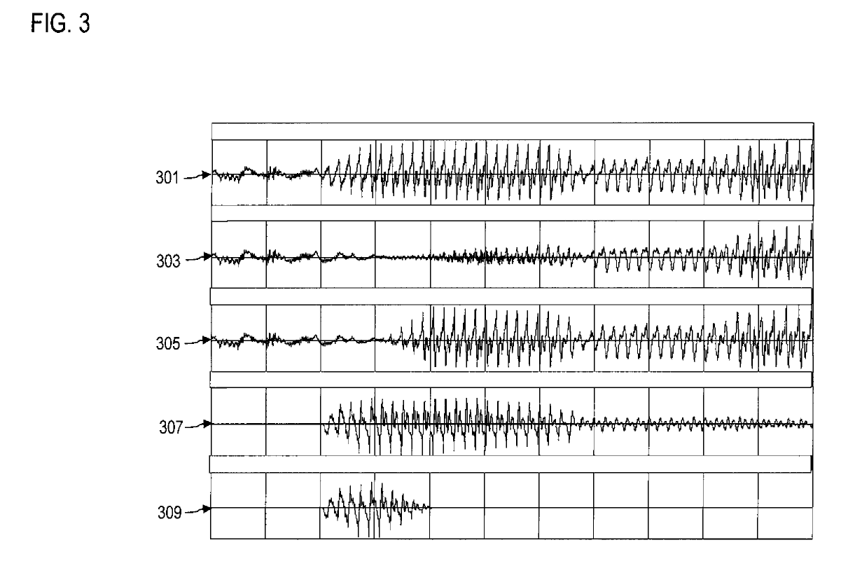

FIG. 3 is a diagram of decoded signals of a conventional concealment procedure and of a late packet processing procedure according to an embodiment of the invention. Signal 301 is the output of a decoder when no frame is lost. Signal 303 is the output of the decoder when the 3rd frame is lost and concealed. Since that loss occurs during a voiced onset, it triggers a strong energy loss (spanning one complete phoneme) and a high distortion level. In that case, the recovery time is long (error signal 307). Signal 305 is the output of the decoder when an update is performed after the concealment using the method described in P. Gournay et al article. Since all the necessary information was available to the decoder in time to be taken into account, the recovery is fast and complete (error signal 309). All the signals (including errors) are represented at the same amplitude scale. While the technique of P. Gournay et al can be efficient at reducing the error propagation after a late packet, it does not handle properly the pitch phase difference introduced by the concealment. In some cases, the fade-in, fade-out operation performed to smooth the transition between the concealed segment and the “updated” segment even breaks the natural periodicity of signal. In those cases, a localized but very audible and unpleasant distortion is produced.

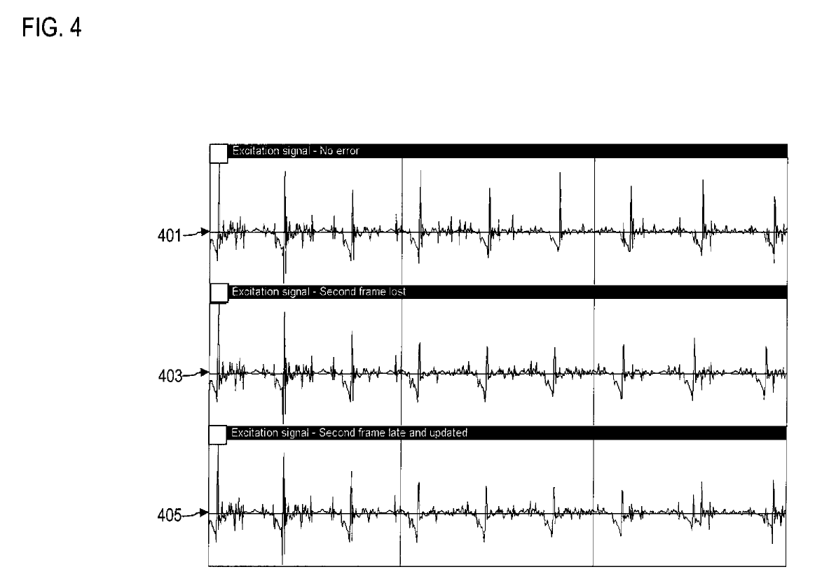

FIG. 4 is a diagram of excitation signals involving use of a conventional concealment procedure and a conventional late packet processing procedure. Signal 401 is the excitation signal computed by the decoder 107 when no frame is lost. Signal 403 is the excitation signal when the second frame is considered as lost and concealed. A pitch phase difference is introduced by the concealment 103 and propagated afterwards by the decoder 107; it is clearly visible as signal 401 and signal 403 are desynchronized in the third frame. Signal 405 is the excitation signal when the same frame is used to update the internal state. The pitch periodicity is clearly broken during the third frame where the fade-in, fade-out operation is performed (the fade-in, fade-out procedure produces two pitch pulses around the middle of the third frame that are too closely spaced and not energetic enough).

An approach for determining and utilizing pitch phase difference for smoothing the transition between a concealed frame and a subsequent frame is now more fully described. The transition is performed in such a way that it does not break the natural pitch periodicity of the speech or audio signal.

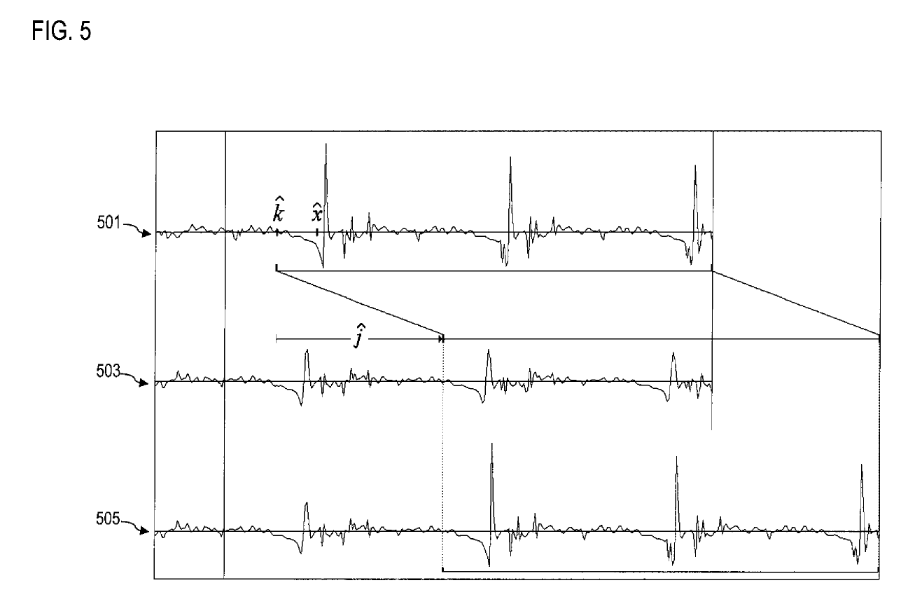

FIG. 5 is a diagram of the relationships among the signals utilized in a resynchronization procedure, according to an embodiment of the invention. Specifically, FIG. 5 shows the relationships among, \hat{x}, ĵ and \hat{k} in the frame immediately following a late frame. Signal 501 is the original signal without errors, signal 503 is the signal just after the loss of the previous frame (note the phase difference of the pitch pulses), and signal 505 is the signal after update and resynchronization (note that signal 501 has been realigned with signal 503 here). \hat{x} marks the beginning of the window used in finding the first pitch pulse in the good excitation, ĵ is the offset between the two signals, and \hat{k} is the minimum energy point where signals 501 and 503 are joined to form signal 505. It is noted that ĵ is not only the offset between signals 501 and 503, but also the additional length of signal 505.

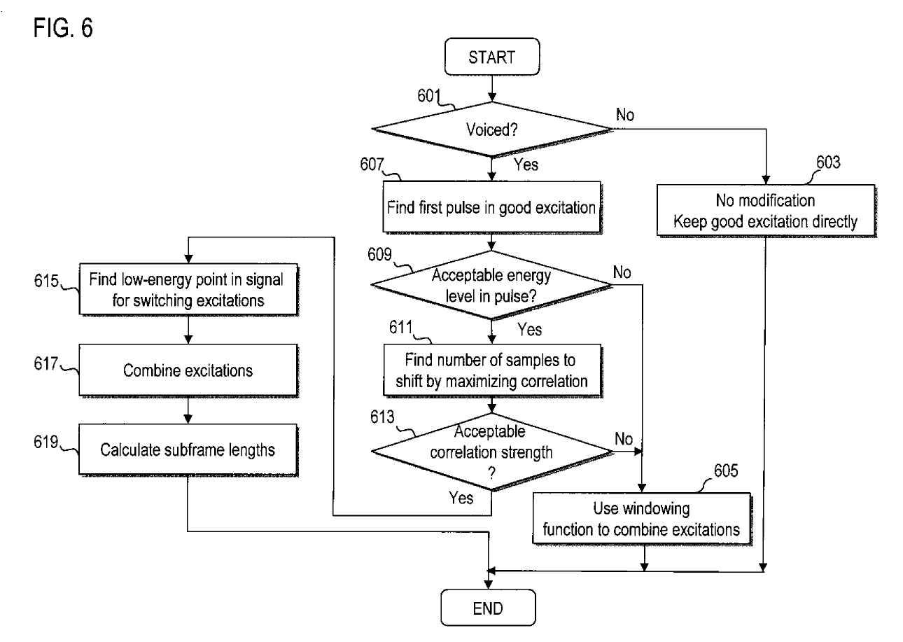

FIG. 6 is a flowchart of a resynchronization procedure, according to an embodiment of the invention. The resynchronization procedure is explained, according to one embodiment of the invention, in the context of a Code Excited Linear Prediction (CELP) coder/decoder (codec) with modifications applied to the excitation signal computed by the decoder 107 of FIG. 1A. However, depending on the application, the resynchronization procedure can alternatively be performed following similar steps on the decoded output signal. For the purposes of illustration, the specific implementations provided below are for the Variable Multi-Rate Wideband Codec (VMR-WB) codec, parameters in other codecs may be different but the same principles apply. In the system of FIG. 1A, the procedure provides for resynchronization the internal state of the decoder 107 with an internal state of an encoder (not shown) using the late frame.

In step 601, the audio system 100 determines whether a received packet is a “voiced” packet. By way of example, “voiced” indicates periodic or quasi periodic speech signal where pitch pulses can be detected (e.g., as in the sounds /a/, /e/ etc.). On the contrary, unvoiced speech signal is more noise like and pitch pulses cannot be detected due to a lack of periodicity (e.g., /s/). Thus, block 601 discriminates voiced and unvoiced speech frames. If the packet is not a voiced packet, no resynchronization is necessary, and thus, no modification is needed, whereby the good excitation is kept, per step 603. For illustrative purposes, the term “good” excitation refers to signal (iii) in FIG. 2 and “bad” excitation signal (i). The good excitation is the excitation signal as it would have been had the preceding frame not been late, and the bad excitation is the excitation signal as it would have been had the preceding frame not been recovered. The memory of the good excitation is also available for use; it is assumed to be continuous with the present good excitation (therefore, negative indices can be used as the “good” excitation begins in the present frame). The procedure is applied to voiced signals (i.e., signals that exhibit a certain degree of periodicity). The symbol “T₀” is used to represent the pitch period, and refers to the pitch of the first subframe in the good excitation (unless otherwise noted). T₀ is a known parameter transmitted in the coded speech packet.

If, however, the packet is associated with a voiced signal, the system 100, in step 607, finds the first pulse with the good excitation. Then the system per step 609 determines whether acceptable energy level is in pulse. If so, in step 611, the system finds number of samples to shift by maximizing correlation.

More specifically, the following addresses the problem of resynchronizing two out-of-phase voiced signals. First, find a glottal pulse to be used in the synchronization (as in step 607), this can be found in either the good or bad excitation. Second, this pulse is shifted across the other excitation to find where the pulse correlates best (step 611). Third, a minimum energy point near the pulse is determined where the switch from the bad to good excitation can be made.

In an exemplary embodiment, the glottal pulse can be the first pulse in the good excitation. Shifting a window of size W₁ across the first T₀+W₁ samples of the good excitation, and taking the position with the maximum energy, gives the location of the glottal pulse (step 607). Slightly more than T₀ samples are used to avoid borderline cases when part of a pulse lies on the 0^{th} or T₀^{th} sample. (1) below describes the algorithm used to find the first glottal pulse. \hat{x} is the first sample of the W₁-sample window containing the pulse:

$$\hat{x} = {arg max}_{x} ( {\sum }_{i = 0}^{i = {W}_{1} - 1} {good [ i + x ]}^{2} ) , 0 \leq x \leq {T}_{0} , \qquad ( 1 )$$

and good[n] is the n^{th} sample of the good excitation. For the VMR-WB codec, W₁ can be set to 10.

Finding the first pulse in the bad excitation can also be used, however, this approach is relatively less attractive, as the concealed pulses are often less distinct than the good pulses and are therefore not always correctly found. Other bounds on x, such as centering the search on 0 or performing a shorter or longer search, were also tried, with the bounds given in Equation (1) yielding better results with the VMR-WB.

Equation (2) below measures the percentage of energy stored in the glottal pulse found from Equation (1) with respect to the amount of energy in a fixed period (“Tₘᵢₙ” represents the minimum possible pitch period allowed by the codec) centered at the glottal pulse; E represents this percentage. It may be useful to set a floor on E to protect against pulses being falsely identified (per step 609). For example, a possible value for this floor could be set at 80 percent to protect false pulses from being identified as pulses. This energy comparison also protects against a signal being poorly synchronized, and thus causing the sound quality in some instances to be worse than the method described in P. Gournay et al.

$$E = \frac{{\sum }_{i = 0}^{i = {W}_{1} - 1} {good [ i + \hat{x} ]}^{2}}{{\sum }_{i = 0}^{{T}_{min} - 1} {good [ i + \hat{x} - \frac{{T}_{min}}{2} ]}^{2}} * 100 \qquad ( 2 )$$

Once the first pulse in the good excitation is found and the energy constraint is deemed satisfactory, the total number of samples by which the good and bad excitations are offset (i.e., the amount needed to shift them for resynchronization), ĵ, is found by shifting the pulse across the bad excitation and maximizing the correlation according to (3) below.

$$\hat{j} = {arg max}_{j} ( \frac{{\sum }_{i = 0}^{i = {W}_{2} - 1} good [ \hat{x} + i ] * bad [ \hat{x} + i + j ]}{{\sum }_{i = 0}^{i = {W}_{2} - 1} {good [ \hat{x} + i ]}^{2}} ) , 0 \leq j < {T}_{0} and j < FL - {W}_{2} - \hat{x} \qquad ( 3 )$$

In this equation, FL (Frame Length) is the number of samples in a standard-sized frame (e.g., 256 in the VMR-WB), and W₂ is the size of the window used to calculate the correlation (e.g., W₂=15). According to one embodiment of the invention, the correlation implemented is normalized only by the energy in the good excitation. This parameter is a matter of preference and could also be normalized in other ways (i.e., either both the good and bad energies, or just the bad energy). However, using different correlation calculation methods result in different ĵ's, and thus the method that works best for any given system can be determined.

If an acceptable correlation strength is determined, per step 613, the low-energy point in the signal for switching excitations is found. Then, the process combines the excitations and calculates subframe lengths (per steps 617 and 619).

If, however, the process fails to find an acceptable energy level (step 605), a windowing function is invoked to combine the excitations. By way of example, any standard or conventional process can be used for this windowing function.

To avoid resynchronizing signals that do not line up well, a floor for the correlation could be used, step 613. A value used in the present case, for example, was 0.60. Any signals giving correlations less than the selected floor may be modified (e.g., according to P. Gournay et al.).

Due to constraints, for upsampling purposes, on the size of the frame, the length of each 12.8 kHz frame in the VMR-WB should be divisible by 4, in this example. Therefore, the ĵ found is rounded to the nearest multiple of 4.

This exemplary arrangement allows for samples to be added to a frame and not to be removed, i.e. ĵ is always greater than or equal to 0. This is performed, for instance, to obtain beneficial side-effects pertaining to a real-time voice over IP network scheme. However, if desired, it is also possible to allow for samples to be removed from a frame, i.e., have a ĵ less than 0. This can be realized by modifying the bound on j in Equation (3) to include negative indices as desired.

After finding the number of samples to offset the good excitation in order to align it with the bad excitation, a low-energy point in the signal can be found where the change from the bad to good excitation may take place (step 615). This is necessary to avoid introducing unwanted artifacts by making an abrupt energy change. Since the all of the modifications are performed in the excitation domain, the synthesis filters will smooth any small changes out—hence, this does not pose a problem.

According to one embodiment of the invention, the search for the minimum energy point, \hat{k}, is performed by sliding a window of W₃ samples (e.g., 10 samples) across the T₀/2 samples preceding \hat{x}^{th} sample in the good excitation (see Equation (4)).

$$\hat{k} = {arg min}_{k} ( {\sum }_{i = 0}^{i = {W}_{3} - 1} {good [ \hat{x} - k + i ]}^{2} ) , {W}_{3} \leq k \leq \frac{{T}_{0}}{2} + {W}_{3} \qquad ( 4 )$$

In some cases, when \hat{x} is close to 0, the search uses the good excitation memory (i.e., the negative indices of the good excitation), but this only poses a problem if:
ĵ+\hat{k}<0 (5)
in which case the \hat{k} found before the pulse occurs in the preceding frame, which is already past playout time, even after shifting the excitation by ĵ. This essentially indicates to the decoder 107 to switch from the bad to good excitation before the frame actually starts—which is not technically sound. Therefore, a new search can be done to find the minimum energy point just after the first pulse in the good excitation.

$$if ( \hat{j} + \hat{k} < 0 ) then redo with : - {W}_{3} \leq k \leq - \frac{{T}_{0}}{2} - {W}_{3} \qquad ( 6 )$$

Now that the amount to shift and where to merge the two signals has been found, the good and bad excitations are brought together (step 617). In the new frame that is made up of both the good and bad excitations, the first min {FL,ĵ+\hat{k}} samples belong to the bad excitation while the final FL−\hat{k} samples come from the good excitation. In the case where ĵ+\hat{k}>FL, the (ĵ+\hat{k})−FL samples between the bad and good excitations should be set to zero. Therefore the length of the new frame is FL+ĵ.

According to an exemplary embodiment, in the VMR-WB codec, two excitation signals are defined: one that is used for the adaptive codebook memory, and one that is post-processed and used only for synthesis. In the synthesis process, both are used, so it is important that any modifications made to one signal needs to be performed identically to the other signal. In the method employed herein, all calculations are performed on the excitation that is used solely for synthesis, but at the end of the algorithm, both excitations get offset and saved as described in the previous paragraph.

By way of example, the VMR-WB codec uses 4 subframes, whereas other codecs may differ in this regard. At the end of the resynchronization process, if the frame size is changed (i.e., if ĵ!=0), the size of the correct subframe is changed to reflect this difference, per step 619. Post-filtering on the signal is performed on a subframe-by-subframe basis, thus, the sum of the subframe lengths needs to correspond to the length of the entire signal. The subframe length that should be modified is the subframe in which \hat{k} is located, and the entire value of ĵ should be added to the original length of the subframe. The new frame length is FL+ĵ; i.e., the length is increased by ĵ, and this needs to be reflected in the subframes.

Under this scenario, it is assumed that ĵ is positive (i.e., the new frame is always longer than the normal frame length). However, as mentioned earlier, it is also possible to shorten a frame, and in this case, the subframe lengths should be modified to reflect which parts of the signal were kept or not.

As explained calculations and modifications described above are performed on the excitation signal in a CELP-based codec, for the purposes of illustration. The modifications could also be carried out on the PCM signal with the use of Pitch-Synchronous Overlap-and-Add (PSOLA) or other techniques. With respect to performing the modifications on the excitation signal however, the Pulse Code Modulation (PCM) signal is significantly more computationally complex.

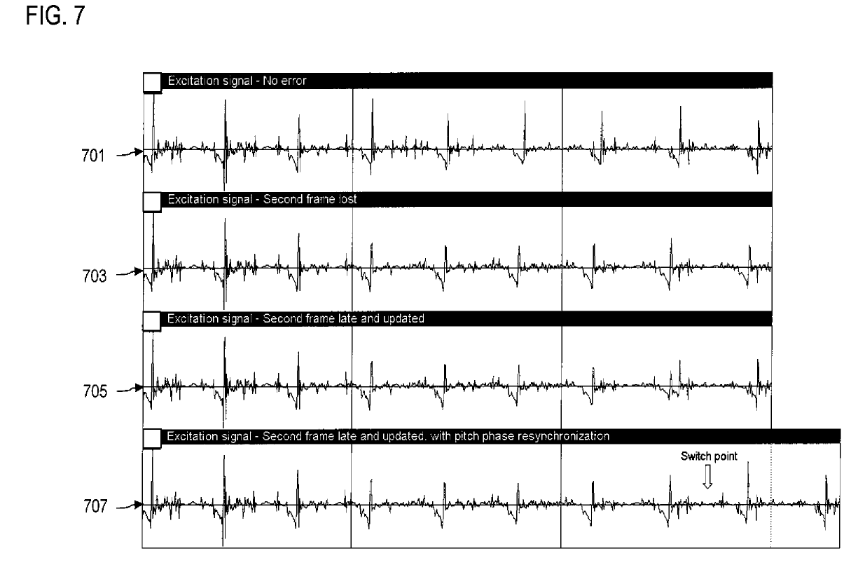

FIG. 7 is a diagram of excitation signals involving use of the resynchronization procedure, according to an embodiment of the invention. Signals 701, 703 and 705 resemble that of FIG. 4. Signal 707 is the excitation signal generated by the late packet processing of the system 100. The excitation signal for the first frame is the same in all lines as no error occurred before. Since the concealment procedure has not changed, the second frame is also the same in signals 703, 705 and 707. Late packet processing can be performed during the third frame, using the method described in P. Gournay et al. The pitch periodicity is clearly well maintained in signal 707. An arrow indicates the switch point between the excitation signal that extends the concealment and the (good) excitation signal after the internal state update. The excitation signal before the switch point can correspond exactly to the “extended” concealed excitation. The excitation signal after the switch point (last two pitch pulses) corresponds exactly (with a delay of one third of a frame) with the “good” excitation signal 701. The output frame is approximately one third longer than usual and contains one more pitch pulse than the good excitation.

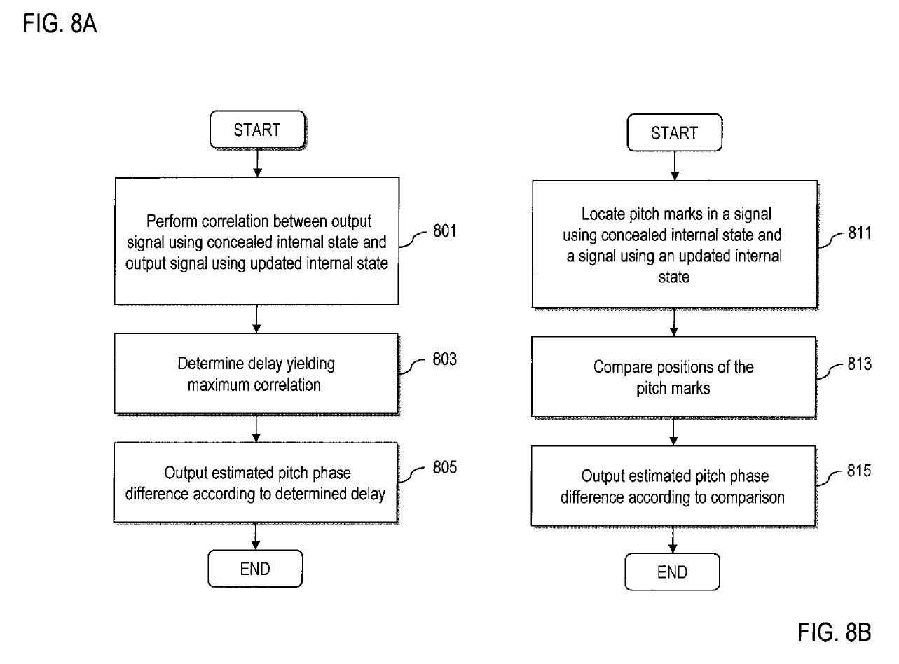

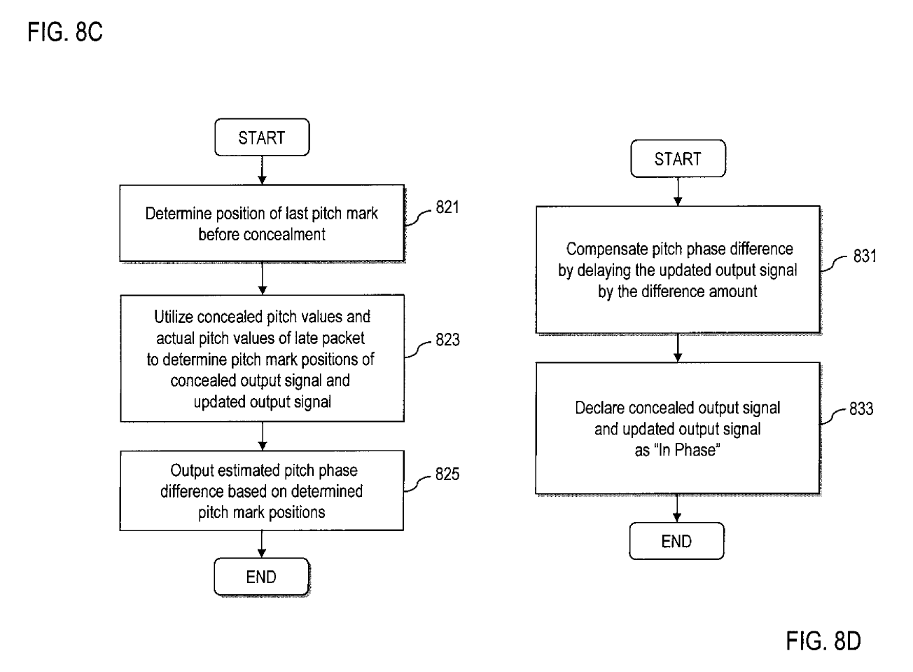

FIGS. 8A-8D are flowcharts of processes associated with determining and accounting for pitch phase difference, according to various embodiments of the invention. In FIG. 8A, in the implementation presented above, as in step 801, the difference can be found by performing a correlation between the output signal computed using the concealed internal state (e.g., signal (i) of FIG. 2) on the one hand, and the output signal computed using the updated internal state (e.g., signal (iii) of FIG. 2) on the other hand. It is noted that correlation can be determined between signals that are either decoder output signals or internal decoder signals (e.g., excitation signals). In step 803, the process determines the delay that produces the maximum correlation is the estimated pitch phase difference and, outputs the estimated pitch phase difference according to determined delay (step 805).

As shown in FIG. 8B, in step 811, the pitch phase difference may also be determined by first finding the pitch marks in a signal using concealed internal state (i) and a signal using updated internal state (iii) (using for example the Pitch-Synchronous Overlap-and-Add (PSOLA) algorithm). In step 813, the process compares the position of those pitch marks and outputs an estimated pitch phase difference according to determined delay in step 815. Alternatively, FIG. 8C shows that the pitch difference may be obtained, per step 821, by first determining the position of the last pitch mark before the concealment, then using the concealed pitch values and the actual pitch values found in the late packet to determine the pitch mark positions in signal (i) and signal (iii) (per step 823). Thereafter, in step 825, the process outputs the estimated pitch phase difference based on determined pitch mark positions.

In FIG. 8D, according to an exemplary embodiment (shown in FIG. 8D), in step 831, the pitch phase difference introduced by the concealment is compensated by delaying signal (iii) by the same amount. At this point, the two signals (i) and (iii) are “in phase” (per step 833). Consequently, it is possible to switch rapidly from one signal to the other without breaking the periodicity. Because a delay has been applied to signal (iii) however, the resulting “transitional” output frame is longer than usual. In some applications, this poses no problem and is even desirable (i.e., when the decoder is combined with an adaptive jitter buffer, a longer output frame increases the playout delay which reduces the probability of receiving another late packet). In other applications where a constant output frame duration is required, a “transitional” output frame with a normal length may be obtained by slightly shifting back individual pulses in signals (i) and/or (iii) by a fraction of the error introduced during the concealment before switching from one signal to the other.

One advantage of the approach described above is that it improves the subjective quality of the decoded signal after a late packet has been processed. More specifically, the pitch phase difference that is generally introduced by the concealment procedure during voiced speech or periodic or quasi-periodic audio signals is determined and taken into account by the late packet processing procedure in order to smooth the transition between the concealed output signal and the output signal computed with an updated internal state. A second advantage is that it allows for a faster (with respect to the usual “fade-in, fade-out” approach) switch between the concealed output signal and the “updated” output signal. Another advantage is that it produces output frames that are generally longer than the normal frame duration after a late packet has been received. This increases the playout delay, and thus reduces the probability of receiving yet another late frame.

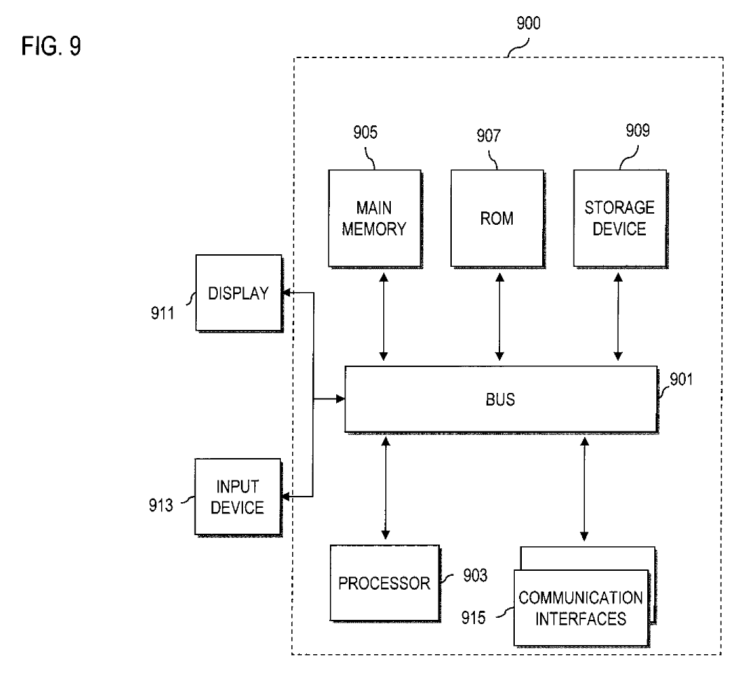

One of ordinary skill in the art would recognize that the processes for pitch phase resynchronization may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exempla hardware for performing the described functions is detailed below with respect to FIG. 9.

FIG. 9 illustrates exemplary hardware upon which various embodiments of the invention can be implemented. A computing system 900 includes a bus 901 or other communication mechanism for communicating information and a processor 903 coupled to the bus 901 for processing information. The computing system 900 also includes main memory 905, such as a random access memory (RAM) or other dynamic storage device, coupled to the bus 901 for storing information and instructions to be executed by the processor 903. Main memory 905 can also be used for storing temporary variables or other intermediate information during execution of instructions by the processor 903. The computing system 900 may further include a read only memory (ROM) 907 or other static storage device coupled to the bus 901 for storing static information and instructions for the processor 903. A storage device 909, such as a magnetic disk or optical disk, is coupled to the bus 901 for persistently storing information and instructions.

The computing system 900 may be coupled via the bus 901 to a display 911, such as a liquid crystal display, or active matrix display, for displaying information to a user. An input device 913, such as a keyboard including alphanumeric and other keys, may be coupled to the bus 901 for communicating information and command selections to the processor 903. The input device 913 can include a cursor control, such as a mouse, a trackball, or cursor direction keys, for communicating direction information and command selections to the processor 903 and for controlling cursor movement on the display 911.

According to various embodiments of the invention, the processes described herein can be provided by the computing system 900 in response to the processor 903 executing an arrangement of instructions contained in main memory 905. Such instructions can be read into main memory 905 from another computer-readable medium, such as the storage device 909. Execution of the arrangement of instructions contained in main memory 905 causes the processor 903 to perform the process steps described herein. One or more processors in a multi-processing arrangement may also be employed to execute the instructions contained in main memory 905. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 900 also includes at least one communication interface 915 coupled to bus 901. The communication interface 915 provides a two-way data communication coupling to a network link (not shown). The communication interface 915 sends and receives electrical, electromagnetic, or optical signals that carry digital data streams representing various types of information. Further, the communication interface 915 can include peripheral interface devices, such as a Universal Serial Bus (USB) interface, a PCMCIA (Personal Computer Memory Card International Association) interface, etc.

The processor 903 may execute the transmitted code while being received and/or store the code in the storage device 909, or other non-volatile storage for later execution. In this manner, the computing system 900 may obtain application code in the form of a carrier wave.

The term “computer-readable medium” as used herein refers to any medium that participates in providing instructions to the processor 903 for execution. Such a medium may take many forms, including but not limited to non-volatile media, volatile media, and transmission media. Non-volatile media include, for example, optical or magnetic disks, such as the storage device 909. Volatile media include dynamic memory, such as main memory 905. Transmission media include coaxial cables, copper wire and fiber optics, including the wires that comprise the bus 901. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

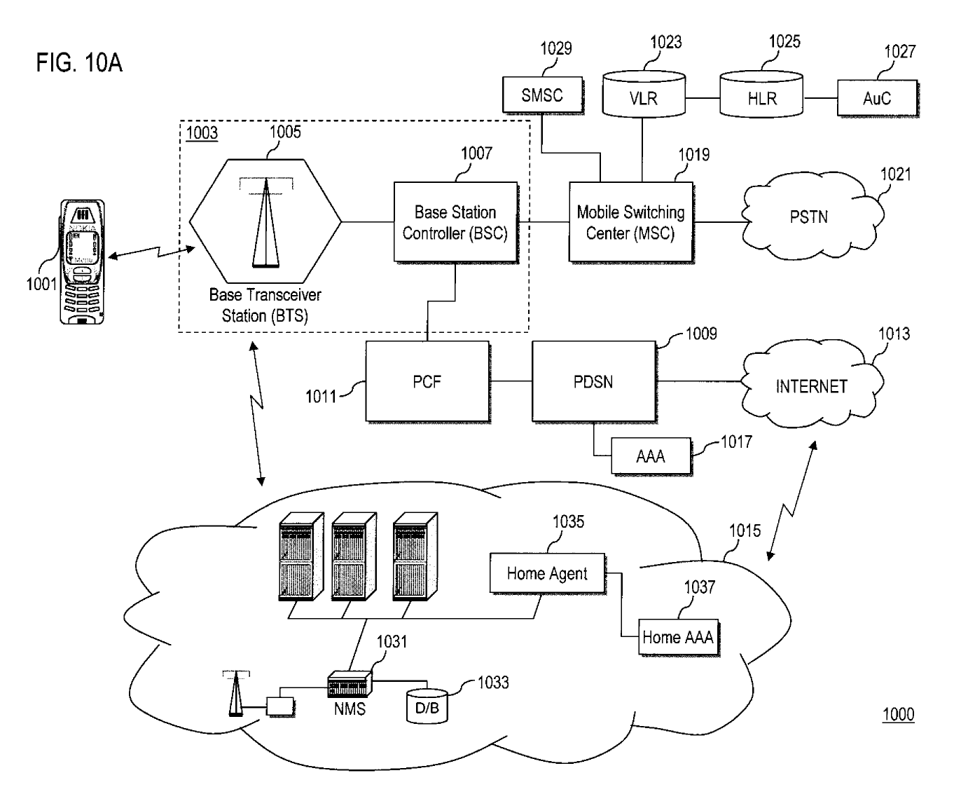

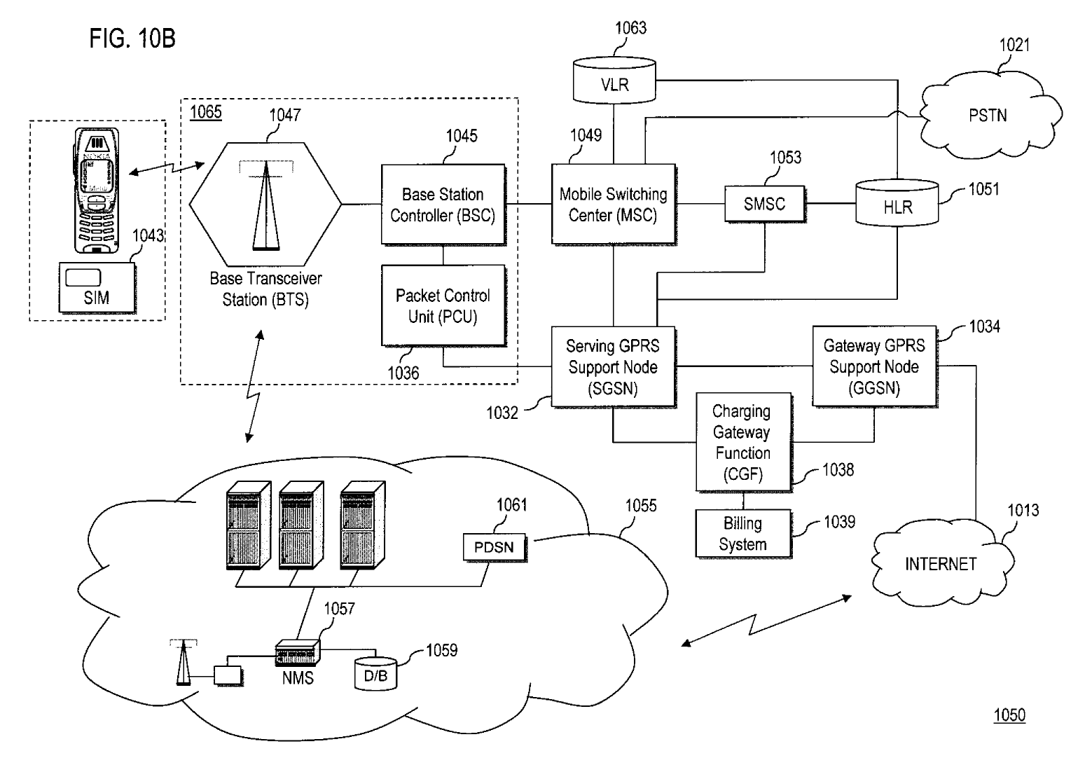

FIGS. 10A and 10B are diagrams of different cellular mobile phone systems capable of supporting various embodiments of the invention. FIGS. 10A and 10B show exemplary cellular mobile phone systems each with both mobile station (e.g., handset) and base station having a transceiver installed (as part of a Digital Signal Processor (DSP)), hardware, software, an integrated circuit, and/or a semiconductor device in the base station and mobile station). By way of example, the radio network supports Second and Third Generation (2G and 3G) services as defined by the International Telecommunications Union (ITU) for International Mobile Telecommunications 2000 (IMT-2000). For the purposes of explanation, the carrier and channel selection capability of the radio network is explained with respect to a cdma2000 architecture. As the third-generation version of IS-95, cdma2000 is being standardized in the Third Generation Partnership Project 2 (3GPP2).

A radio network 1000 includes mobile stations 1001 (e.g., handsets, terminals, stations, units, devices, or any type of interface to the user (such as “wearable” circuitry, etc.)) in communication with a Base Station Subsystem (BSS) 1003. According to one embodiment of the invention, the radio network supports Third Generation (3G) services as defined by the International Telecommunications Union (ITU) for International Mobile Telecommunications 2000 (IMT-2000).

In this example, the BSS 1003 includes a Base Transceiver Station (BTS) 1005 and Base Station Controller (BSC) 1007. Although a single BTS is shown, it is recognized that multiple BTSs are typically connected to the BSC through, for example, point-to-point links. Each BSS 1003 is linked to a Packet Data Serving Node (PDSN) 1009 through a transmission control entity, or a Packet Control Function (PCF) 1011. Since the PDSN 1009 serves as a gateway to external networks, e.g., the Internet 1013 or other private consumer networks 1015, the PDSN 1009 can include an Access, Authorization and Accounting system (AAA) 1017 to securely determine the identity and privileges of a user and to track each user's activities. The network 1015 comprises a Network Management System (NMS) 1031 linked to one or more databases 1033 that are accessed through a Home Agent (HA) 1035 secured by a Home AAA 1037.

Although a single BSS 1003 is shown, it is recognized that multiple BSSs 1003 are typically connected to a Mobile Switching Center (MSC) 1019. The MSC 1019 provides connectivity to a circuit-switched telephone network, such as the Public Switched Telephone Network (PSTN) 1021. Similarly, it is also recognized that the MSC 1019 may be connected to other MSCs 1019 on the same network 1000 and/or to other radio networks. The MSC 1019 is generally collocated with a Visitor Location Register (VLR) 1023 database that holds temporary information about active subscribers to that MSC 1019. The data within the VLR 1023 database is to a large extent a copy of the Home Location Register (HLR) 1025 database, which stores detailed subscriber service subscription information. In some implementations, the HLR 1025 and VLR 1023 are the same physical database; however, the HLR 1025 can be located at a remote location accessed through, for example, a Signaling System Number 7 (SS7) network. An Authentication Center (AuC) 1027 containing subscriber-specific authentication data, such as a secret authentication key, is associated with the HLR 1025 for authenticating users. Furthermore, the MSC 1019 is connected to a Short Message Service Center (SMSC) 1029 that stores and forwards short messages to and from the radio network 1000.

During typical operation of the cellular telephone system, BTSs 1005 receive and demodulate sets of reverse-link signals from sets of mobile units 1001 conducting telephone calls or other communications. Each reverse-link signal received by a given BTS 1005 is processed within that station. The resulting data is forwarded to the BSC 1007. The BSC 1007 provides call resource allocation and mobility management functionality including the orchestration of soft handoffs between BTSs 1005. The BSC 1007 also routes the received data to the MSC 1019, which in turn provides additional routing and/or switching for interface with the PSTN 1021. The MSC 1019 is also responsible for call setup, call termination, management of inter-MSC handover and supplementary services, and collecting, charging and accounting information. Similarly, the radio network 1000 sends forward-link messages. The PSTN 1021 interfaces with the MSC 1019. The MSC 1019 additionally interfaces with the BSC 1007, which in turn communicates with the BTSs 1005, which modulate and transmit sets of forward-link signals to the sets of mobile units 1001.

As shown in FIG. 10B, the two key elements of the General Packet Radio Service (GPRS) infrastructure 1050 are the Serving GPRS Supporting Node (SGSN) 1032 and the Gateway GPRS Support Node (GGSN) 1034. In addition, the GPRS infrastructure includes a Packet Control Unit PCU (1036) and a Charging Gateway Function (CGF) 1038 linked to a Billing System 1039. A GPRS the Mobile Station (MS) 1041 employs a Subscriber Identity Module (SIM) 1043.

The PCU 1036 is a logical network element responsible for GPRS-related functions such as air interface access control, packet scheduling on the air interface, and packet assembly and re-assembly. Generally the PCU 1036 is physically integrated with the BSC 1045; however, it can be collocated with a BTS 1047 or a SGSN 1032. The SGSN 1032 provides equivalent functions as the MSC 1049 including mobility management, security, and access control functions but in the packet-switched domain. Furthermore, the SGSN 1032 has connectivity with the PCU 1036 through, for example, a Fame Relay-based interface using the BSS GPRS protocol (BSSGP). Although only one SGSN is shown, it is recognized that that multiple SGSNs 1031 can be employed and can divide the service area into corresponding routing areas (RAs). A SGSN/SGSN interface allows packet tunneling from old SGSNs to new SGSNs when an RA update takes place during an ongoing Personal Development Planning (PDP) context. While a given SGSN may serve multiple BSCs 1045, any given BSC 1045 generally interfaces with one SGSN 1032. Also, the SGSN 1032 is optionally connected with the HLR 1051 through an SS7-based interface using GPRS enhanced Mobile Application Part (MAP) or with the MSC 1049 through an SS7-based interface using Signaling Connection Control Part (SCCP). The SGSN/HLR interface allows the SCSN 1032 to provide location updates to the HLR 1051 and to retrieve GPRS-related subscription information within the SGSN service area. The SGSN/MSC interface enables coordination between circuit-switched services and packet data services such as paging a subscriber for a voice call. Finally, the SGSN 1032 interfaces with a SMSC 1053 to enable short messaging functionality over the network 1050.

The GGSN 1034 is the gateway to external packet data networks, such as the Internet 1013 or other private customer networks 1055. The network 1055 comprises a Network Management System (NMS) 1057 linked to one or more databases 1059 accessed through a PDSN 1061. The GGSN 1034 assigns Internet Protocol (IP) addresses and can also authenticate users acting as a Remote Authentication Dial-In User Service host. Firewalls located at the GGSN 1034 also perform a firewall function to restrict unauthorized traffic. Although only one GGSN 1034 is shown, it is recognized that a given SGSN 1032 may interface with one or more GGSNs 1033 to allow user data to be tunneled between the two entities as well as to and from the network 1050. When external data networks initialize sessions over the GPRS network 1050, the GGSN 1034 queries the HLR 1051 for the SGSN 1032 currently serving a MS 1041.

The BTS 1047 and BSC 1045 manage the radio interface, including controlling which Mobile Station (MS) 1041 has access to the radio channel at what time. These elements essentially relay messages between the MS 1041 and SGSN 1032. The SGSN 1032 manages communications with an MS 1041, sending and receiving data and keeping track of its location. The SGSN 1032 also registers the MS 1041, authenticates the MS 1041, and encrypts data sent to the MS 1041.

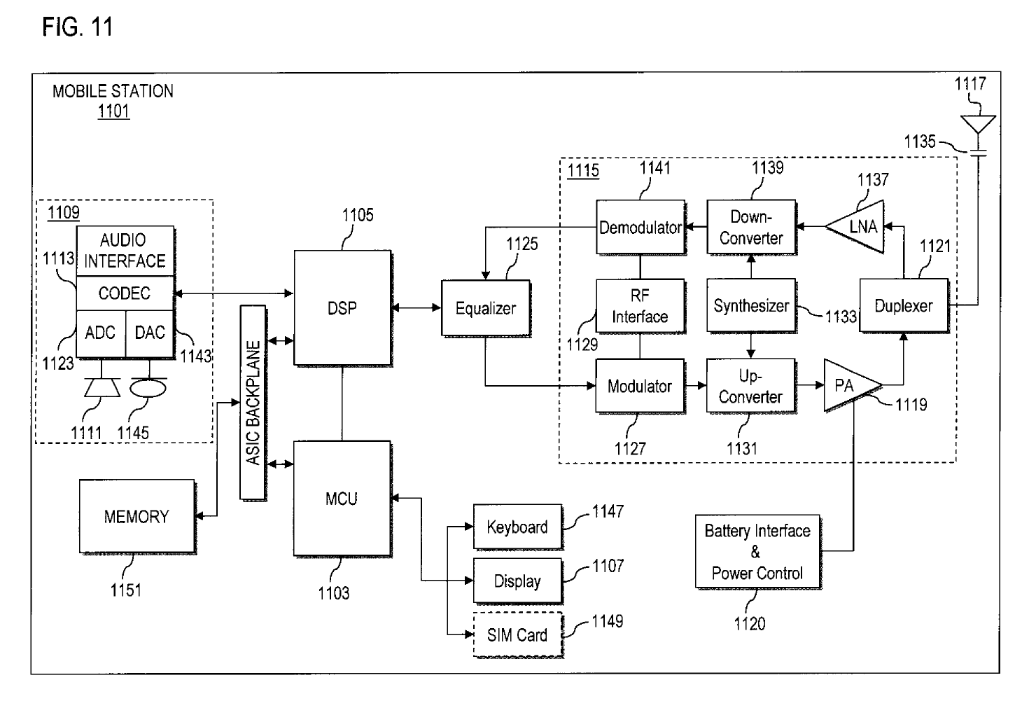

FIG. 11 is a diagram of exemplary components of a mobile station (e.g., handset) capable of operating in the systems of FIGS. 10A and 10B, according to an embodiment of the invention. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile station functions. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system (e.g., systems of FIG. 10A or 10B), via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile station 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In the exemplary embodiment, the processed voice signals are encoded, by units not separately shown, using the cellular transmission protocol of Code Division Multiple Access (CDMA), as described in detail in the Telecommunication Industry Association's TIA/ELA/IS-95-A Mobile Station-Base Station Compatibility Standard for Dual-Mode Wideband Spread Spectrum Cellular System; which is incorporated herein by reference in its entirety.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103—which can be implemented as a Central Processing Unit (CPU) (not shown).

The MCU 1103 receives various signals including input signals from the keyboard 1147. The MCU 1103 delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the station. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile station 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile station 1101 on a radio network. The card 1149 also contains a memory for storing a personal telephone number registry, text messages, and user specific mobile station settings.

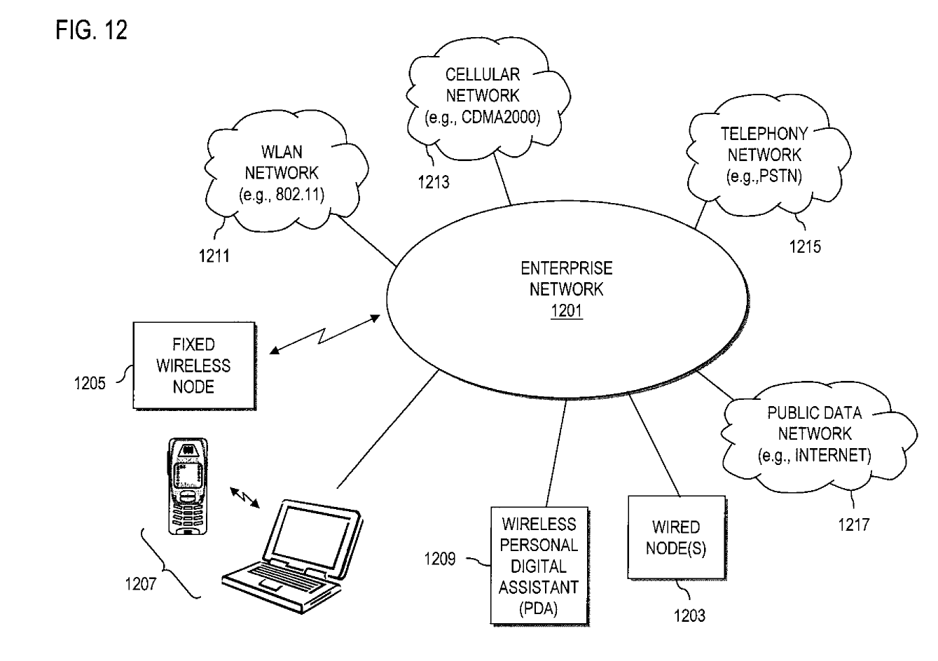

FIG. 12 shows an exemplary enterprise network, which can be any type of data communication network utilizing packet-based and/or cell-based technologies (e.g., Asynchronous Transfer Mode (ATM), Ethernet, IP-based, etc.). The enterprise network 1201 provides connectivity for wired nodes 1203 as well as wireless nodes 1205-1209 (fixed or mobile), which are each configured to perform the processes described above. The enterprise network 1201 can communicate with a variety of other networks, such as a WLAN network 1211 (e.g., IEEE 802.11), a cdma2000 cellular network 1213, a telephony network 1216 (e.g., PSTN), or a public data network 1217 (e.g., Internet).

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
detecting a late frame that includes audio information, wherein concealment has been performed to replace the late frame;
determining a pitch phase difference introduced by the concealment; and
compensating for the pitch phase difference before playing out a subsequent frame that follows the late frame.

2. A method according to claim 1, further comprising:
resynchronizing an internal state of a decoder with an internal state of an encoder using the late frame.

3. A method according to claim 1, wherein the pitch phase difference is determined by:
correlating between a first signal and a second signal;
determining a maximum correlation; and
determining a delay value corresponding to the maximum correlation.

4. A method according to claim 3, wherein the first signal corresponds to the late frame being concealed, and the second signal corresponds to the late frame being properly decoded.

5. A method according to claim 3, wherein the first signal corresponds to the subsequent frame being decoded by using a concealed internal state, and the second signal corresponds to the subsequent frame being decoded using an updated internal state.

6. A method according to claim 1, wherein the pitch phase difference is determined by:
determining a first set of pitch marks corresponding to a first signal and a second set of pitch marks corresponding to a second signal; and
comparing positions of the first sets of pitch marks and the second sets of pitch marks.

7. A method according to claim 6, wherein the first signal corresponds to the late frame being concealed, and the second signal corresponds to the late frame being properly decoded.

8. A method according to claim 6, wherein the first signal corresponds to the subsequent frame being decoded by using a concealed internal state, and the second signal corresponds to the subsequent frame being decoded using the updated internal state.

9. A method according to claim 1, wherein the pitch phase difference is determined by:
determining pitch mark positions of a concealed output signal and a correct output signal using the position of the last pitch mark before concealment of the late frame concealed pitch values and actual pitch values recovered from the late frame; and
comparing the pitch mark positions.

10. A method according to claim 1, wherein compensating for the pitch phase difference includes delaying or time scaling a section of the subsequent frame such that the natural pitch periodicity of a corresponding speech signal is unbroken when passing from a concealed frame to a following updated frame.

11. An apparatus comprising:
a concealment logic configured to replace a late frame,
a logic configured to detect a late frame that includes audio information, wherein concealment has been performed to replace the late frame, and
a pitch phase compensation logic configured to determine a pitch phase difference introduced by the concealment, and to compensate for the pitch phase difference before playing out a subsequent frame that follows the late frame.

12. An apparatus according to claim 11, further comprising:
decoding logic having an internal state that is resynchronize with an internal state of an encoder using the late frame.

13. An apparatus according to claim 11, wherein the pitch phase difference is determined by:
correlating between a first signal and a second signal;
determining a maximum correlation; and
determining a delay value corresponding to the maximum correlation.

14. An apparatus according to claim 13, wherein the first signal corresponds to the late frame being concealed, and the second signal corresponds to the late frame being properly decoded.

15. An apparatus according to claim 13, wherein the first signal corresponds to the subsequent frame being decoded by using a concealed internal state, and the second signal corresponds to the subsequent frame being decoded using an updated internal state.

16. An apparatus according to claim 11, wherein the pitch phase difference is determined by:
determining a first set of pitch marks corresponding to a first signal and a second set of pitch marks corresponding to a second signal; and
comparing positions of the first sets of pitch marks and the second sets of pitch marks.

17. An apparatus according to claim 16, wherein the first signal corresponds to the late frame being concealed, and the second signal corresponds to the late frame being properly decoded.

18. An apparatus according to claim 16, wherein the first signal corresponds to the subsequent frame being decoded by using a concealed internal state, and the second signal corresponds to the subsequent frame being decoded using the updated internal state.

19. An apparatus according to claim 11, wherein the pitch phase difference is determined by:
determining pitch mark positions of a concealed output signal and a correct output signal using concealed pitch values and actual pitch values recovered from the late frame; and
comparing the pitch mark positions.

20. An apparatus according to claim 11, wherein compensating for the pitch phase difference includes delaying or time scaling a section of the subsequent frame such that the natural pitch periodicity of a corresponding speech signal is unbroken when passing from a concealed frame to a following updated frame.

21. A mobile device comprising an apparatus according to claim 11.

22. An audio device comprising an apparatus according to claim 11.

23. A chipset comprising an apparatus according to claim 11.

24. A system comprising:
means for detecting a late frame that includes audio information, wherein concealment is performed to replace the late frame;
means for determining a pitch phase difference introduced by the concealment; and
means for compensating for the pitch phase difference before playing out a subsequent frame that follows the late frame.

25. A system according to claim 1, further comprising:
means for resynchronizing an internal state of a decoder with an internal state of an encoder using the late frame.
